(19) United States
(12) Patent Application Publication
(10) Pub. No.: US 2006/0274534 A1
(43) Pub. Date: Dec. 7, 2006

(54) Housing and projection apparatus having the housing

(76) Inventors: Tai-Li Chang, Miao-Li County (TW); Chun-How Shao, Miao-Li County (TW); Chia-Lun Liu, Miao-Li County (TW)

Correspondence Address: J.C. Patents, Inc.;Suite 250, 4 Venture, Irvine, CA, 92618, US

(21) Appl. No.: 11/439,066

(22) Filed: May 22, 2006

(30) Foreign Application Priority Data
Jun. 6, 2005 (TW) 94118532

(51) Int. Cl. F21V 15/00

(52) U.S. Cl. 362/362

(57) ABSTRACT

A housing and a projection apparatus having the housing are provided. The housing is for accommodating a light source and includes a housing body and a transparent body. The housing body accommodates the light source and has an opening thereon. The transparent body is disposed on the housing body to cover the opening. Moreover, the stray light in the housing passes through the opening and is guided to the outside of the housing body by the transparent body. Therefore, the transparent body is brightened by the stray light and the heat-dissipation problem caused by the stray light projected on the housing can be solved.

### CROSS-REFERENCE TO RELATED APPLICATION

This application claims the priority benefit of Taiwan application serial no. 94118532, filed on Jun. 6, 2005. All disclosure of the Taiwan application is incorporated herein by reference.

### BACKGROUND OF THE INVENTION

1. Field of Invention

The present invention relates to a housing and a projection apparatus having the housing. More particularly, the present invention relates to a housing and a projection apparatus effectively utilizing the stray light in the housing.

2. Description of Related Art

The projection apparatus can project the image on a large screen, so it is convenient for a lot of people to watch the screen together. Therefore, the projection apparatus is usually applied in public areas such as company, school, etc. Moreover, as a big-size tendency in household display device, the projection apparatus is also becoming popular. Therefore, the projection apparatus has turned into a common electronic device in modern life.

FIG. 1 is a schematic view of a conventional projection apparatus. In FIG. 1, the conventional projection apparatus 100 includes a housing 110, a light source (not shown), an optical engine (not shown) and a projection lens 120. The light source and the optical engine are provided within the housing 110, and the projection lens 120 protrudes from inside of the housing 110. The light source provides light beam. After the light beam is turned into an image light beam by the optical engine, the image light beam passes through the projection lens 120 and is projected on a screen (not shown) to form an image. When the projection apparatus 100 operates, a part of the light may leak from the light source or the optical engine to form the stray light, and the stray light is projected on the closed housing 110. Accordingly, the housing 110 absorbs the stray light and accumulates heat, which causes a heat dissipation problem in the projection apparatus, and further affects the optical property of the projection apparatus.

Moreover, the manufacturer may attach a LOGO 112 on the housing 110 for trademark and brand identification. However, as the traditional LOGO 112 does not self-illuminate, it looks rather dull and unobvious, and can not be identified clearly in a dim environment such as a meeting room, etc. The conventional projection apparatus employs an additional light source to light up the LOGO 112 to resolve this problem, but the overall cost is increased.

### SUMMARY OF THE INVENTION

Accordingly, the present invention is directed to a housing and a projection apparatus having the housing, wherein the stray light in the housing is guided to the outside of the housing via a first transparent body, which resolves the problem of heat dissipation caused by the stray light projected on the housing.

Another objective of the present invention is directed to a housing and a projection apparatus having the housing, wherein the first transparent body is brightened by the stray light in the housing, accordingly the cost of an additional light source can be saved and the stray light in the housing can be utilized effectively.

Another objective of the present invention is directed to a housing and a projection apparatus having the housing, wherein the LOGO on the housing can be brightened by using the stray light in the housing.

To achieve the above-mentioned objectives, the present invention provides a housing adapted for accommodating a light source. The housing includes a housing body and a first transparent body. The housing body is adapted for accommodating the light source, and the housing body has an opening thereon. The first transparent body is disposed on the housing body to cover the opening. The stray light in the housing passes through the opening and is guided to the outside of the housing body by the first transparent body.

The present invention also provides a projection apparatus including a light source, an optical engine, a projection lens and a housing. The light source and the optical engine are provided within the housing, and the projection lens protrudes from inside of the housing. The light source provides a light beam to the optical engine. The optical engine processes the light beam from the light source into an image light beam, and the projection lens projects the image light beam. The housing includes a housing body and a first transparent body. Wherein, the housing body is adapted for accommodating the light source, the optical engine and the projection lens, and the housing body has an opening thereon. The first transparent body is disposed on the housing body to cover the opening. Moreover, the stray light generated from the light source or optical engine passes through the opening and is guided to the outside of the housing body by the first transparent body.

The above-mentioned first transparent body is, for example, imbedded in the opening.

The above-mentioned opening is, for example, disposed above the light source.

The above-mentioned housing, for example, further includes a reflective device, disposed within the housing body for reflecting the stray light into the opening.

The above-mentioned housing, for example, further includes a light guide device, disposed within the housing body for guiding the stray light to the opening.

The above-mentioned housing, for example, further includes a second transparent body embedded in the housing body and enclosing the first transparent body. The second transparent body guides the stray light to the outside of the housing body.

The housing body of the present invention has an opening, such that the stray light in the housing can pass through the opening and is guided to the outside of the housing body by the first transparent body. Accordingly, the stray light in the housing can be effectively utilized to brighten the first transparent body, and the first transparent body can display various colors.

In order to the make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating the appearance of a conventional projection apparatus.

FIG. 2A is a schematic view illustrating the appearance of a housing in one embodiment of the present invention.

FIG. 2B is a cross-sectional view of a housing in one embodiment of the present invention.

FIG. 3A is a schematic view illustrating the appearance of a housing in another embodiment of the present invention.

FIG. 3B is a cross-sectional view of a housing in another embodiment of the present invention.

FIG. 4 is a cross-sectional view of a housing in a third embodiment of the present invention.

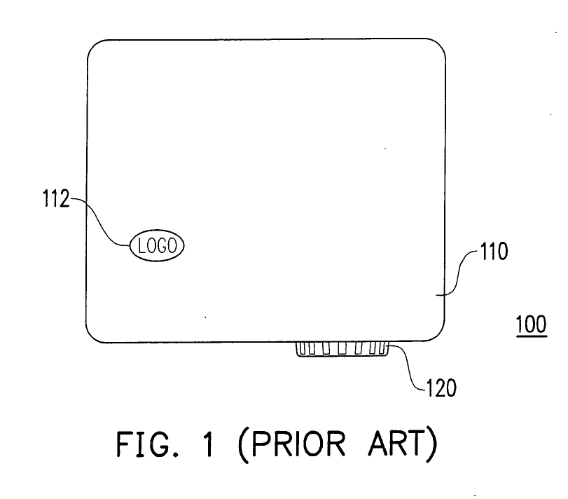

### DESCRIPTION OF THE PREFERRED EMBODIMENTS

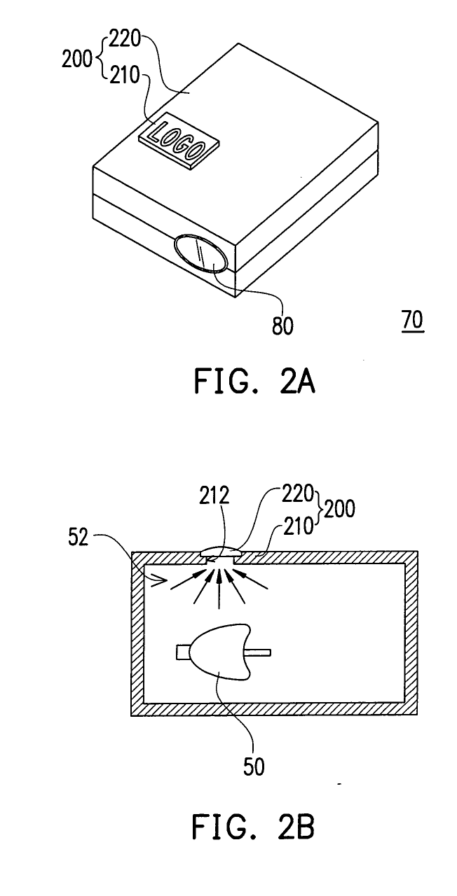

Referring to FIG. 2A and FIG. 2B, a housing 200 in one embodiment of the present invention is suitable for accommodating a light source 50. The housing 200 includes a housing body 210 and a first transparent body 220. The housing body 210 is adapted to accommodate the light source 50 and the housing body 210 has an opening 212. And, the first transparent body 220 is disposed on the housing body 210 to cover the opening 212. Moreover, the stray light 52 in the housing 200 passes through the opening 212 and is guided to the outside of the housing body 210 by the first transparent body 220.

The housing 200 in FIG. 2A is, for example, the housing of a projection apparatus 70. Besides the housing 200, the projection apparatus 70 further includes a light source 50, a projection lens 80 and an optical engine (not shown). The optical engine is disposed within the housing 200, and the projection lens 80 protrudes from inside of the housing 200. The light source 50 provides a light beam to the optical engine. The optical engine processes the light beam from the light source 50 into image light beam, and the projection lens 80 projects the image light beam on a screen (not shown).

The opening 212 of the housing body 210, for example, is disposed above the light source 50, and the first transparent body 220 is, for example, imbedded in the opening 212. Of course, the first transparent body 220 of the present invention can also be directly implemented on the housing body 210 and above the opening 212. Moreover, the first transparent body 220 is, for example, a LOGO, and the material of the LOGO is, for example, transparent material to guide the stray light 52 of the light source 50 to the outside of the housing body 210.

In the present embodiment, when the projection apparatus 70 operates, the stray light 52 leaking from the light source 50 and/or the optical engine within the housing 200 can be guided to the outside of the housing body 210 by the first transparent body 220 of the housing 200. Accordingly, the first transparent body 220 can be brightened by the stray light 52. More particularly, the projection apparatus 70 is usually used in a dim environment, so that the first transparent body 220 would look more obvious. Moreover, the material of the first transparent body 220 can be colored transparent material, so the first transparent body 220 can display more exuberant colors. In addition, in this embodiment, the first transparent body 220 can be printed or paint-sprayed in order to display various patterns.

It is noted that, in the housing 200 of this embodiment according to the present invention, the first transparent body 220 is brightened by the stray light 52 inside the housing 200, so no additional light source is needed. Accordingly, not only can the cost of additional light source be saved, the stray light 52 in the housing 200 can be utilized effectively. In addition, as the stray light 52 can be guided to the outside of the housing 200 by the first transparent body 220, the stray light 52 will not project on the housing 200 nor generate heat, so that the problem of heat dissipation in the conventional projector can be solved.

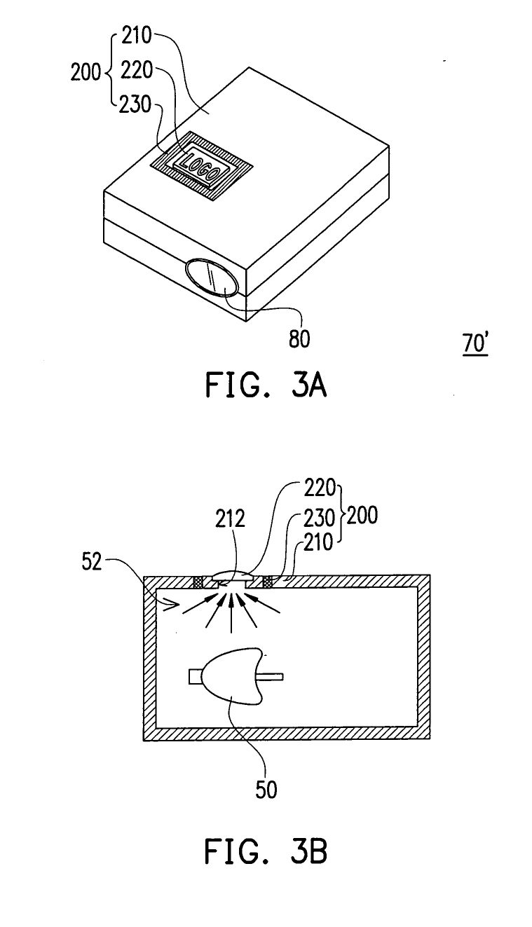

Referring to FIG. 3A and FIG. 3B, another embodiment of the present invention is provided. In the embodiment, a second transparent body 230 is embedded in the housing body 210 and enclosing the first transparent body 220 in order for the LOGO to display more colors. The material of the second transparent body 230 is similar to that of the first transparent body 220, and the stray light 52 of the light source 50 can also be guided to the outside of the housing body 210 by the second transparent body 230. Wherein, the material of the second transparent body 230 is, for example, a transparent material with different color from the first transparent body 220, such as blue or red, etc. Accordingly, the color match of the first transparent body 220 and the second transparent body 230 can be more diverse.

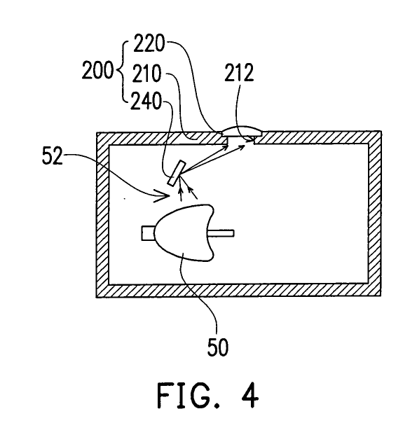

In FIG. 4, a third embodiment of the present invention is provided. In the embodiment, the opening 212 of the housing body 210 can also be disposed in other positions besides the position above the light source 50 (as shown in FIG. 2B and FIG. 3B). And, the stray light 52 in the housing 200 is reflected to the opening 212 by a reflective device 240 provided in the housing 200. Moreover, the reflective device 240 can be replaced by a light guide device (not shown) in the embodiment, so that the stray light 52 can be guided to the opening 212.

In summary, the present invention has at least the following advantages:

1. The first transparent body can be brightened by the stray light without additional light source. Accordingly, the cost of additional light source can be saved, and the stray light can be utilized effectively.

2. The stray light is guided to the outside of the housing by the first transparent body. Accordingly, the stray light will not project on the housing to generate heat, and the conventional heat-dissipation problem can be solved.

3. As the stray light is guided to the outside of the housing by the first transparent body, the first transparent body is brightened by the stray light, and further the LOGO looks more obvious.

4. A second transparent body can be implemented around the first transparent body in the housing body in order for the LOGO to display more colors.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A projection apparatus, comprising:
a light source, for providing a light beam;
an optical engine, for processing the light beam from the light source into an image light beam;
a projection lens, for projecting the image light beam on a screen; and
a housing, comprising:
a housing body, for accommodating the light source, the optical engine and the projection lens, the housing body has an opening thereon; and
a first transparent body disposed on the housing body to cover the opening, wherein stray light in the housing passes through the opening and is guided to an outside of the housing body by the first transparent body.

2. The projection apparatus as claimed in claim 1, wherein a part of the light beam leaks from the optical engine to form the stray light.

3. The projection apparatus as claimed in claim 1, wherein a part of the light beam leaks from the light source to form the stray light.

4. The projection apparatus as claimed in claim 1, wherein the first transparent body is embedded in the opening.

5. The projection apparatus as claimed in claim 1, wherein the opening is disposed above the light source.

6. The projection apparatus as claimed in claim 1, wherein the housing further comprises a reflective device provided within the housing body for reflecting the stray light to the opening.

7. The projection apparatus as claimed in claim 1, wherein the housing further comprises a light guide device provided within the housing body for guiding the stray light to the opening.

8. The projection apparatus as claimed in claim 1, wherein the housing further comprises a second transparent body embedded in the housing body and enclosing the first transparent body, the second transparent body guides the stray light to the outside of the housing body.

9. The projection apparatus as claimed in claim 1, wherein the first transparent body is a LOGO.

10. A housing, for accommodating a light source, comprising:
a housing body for accommodating the light source having an opening thereon; and
a first transparent body disposed on the housing body to cover the opening, wherein stray light in the housing passes through the opening and is guided to an outside of the housing body by the first transparent body.

11. The housing as claimed in claim 10, wherein the first transparent body is embedded in the opening.

12. The housing as claimed in claim 10, wherein the opening is disposed above the light source.

13. The housing as claimed in claim 10, further comprising a reflective device provided in the housing body for reflecting the stray light to the opening.

14. The housing as claimed in claim 10, further comprising a light guide device provided in the housing body for guiding the stray light to the opening.

15. The housing as claimed in claim 10, further comprising a second transparent body embedded in the housing body and enclosing the first transparent body, the second transparent body guides the stray light to the outside of the housing body.

16. The housing as claimed in claim 10, wherein the first transparent body is a LOGO.

17. The housing as claimed in claim 10, wherein a part of light beams provided by the light source leaks from the light source to form the stray light.
